(19) United States
(12) Patent Application Publication
(10) Pub. No.: US 2005/0222913 A1
(43) Pub. Date: Oct. 6, 2005

(54) PR/SMS business method, system and method of conducting business

(76) Inventor: Ian Eisenberg, Seattle, WA (US)

Correspondence Address: John P. Luther, Esq.;Newman & Newman , LLP, Suite 610, 505 Fifth Avenue South, Seattle, WA, 98104, US

(21) Appl. No.: 10/815,368

(22) Filed: Apr. 1, 2004

(51) Int. Cl. G06F 17/60

(52) U.S. Cl. 705/26

(57) ABSTRACT

The present invention provides a method for the purchase of goods and/or services, a system therefor and method of conducting business thereby which comprise and/or employ the steps of a caller or would-be-purchaser calling a service provider/vendor from a mobile phone device; an SMS message being forwarded to the would-be-purchaser's mobile phone device relating to the purchase of services and/or goods options and/or terms of procuring services and/or goods; and upon acceptance of the contents of the SMS message, the would-be-purchaser or caller is billed or charged a fee which allows the caller's access to telephonic and/or Internet vendor provided services and/or goods for a determined time period.

### FIELD OF THE INVENTION

The present invention relates generally to the business of offering and selling goods and services, and in particular to remote transactions in which goods and/or services are ordered or purchased via mobile phone devices in conjunction with Short Message Service (SMS) messages from merchants or service providers.

### BACKGROUND OF THE INVENTION

The Short Message Service (SMS) is an integrated message service that provides the ability to send and receive messages globally to and from other SMS enabled devices, such as mobile telephones. The system is supported by Global System for Mobiles (GSM) and other mobile connection systems. Using the SMS, a message may be transmitted composed of up to 160 characters of any kind of text in length, and can comprise any combination of words, numbers, alphanumeric, punctuation symbols, or they may also be in non-text, such as binary.

SMS messages are said to be similar to paging systems, except that delivery of SMS messages does not require a mobile phone to be active or even within range. Messages are not sent directly to the recipient but instead are sent to a recipient via a network SMS center, and are held in the SMS center or depository until the intended recipient's phone is active and within range. Thus, SMS messages can always be expected to be delivered to the intended recipient eventually. Another feature of the SMS system is that the sender of an SMS message can receive confirmation of message delivery, or notification of whether the short message has been delivered. In some instances several short messages can be strung together (concatenated). Various service providers offer different uses for the SMS system, such as the Bulk SMS system which can be incorporated into an existing messaging system and used to automate and/or send personalized text messages to local, regional or global recipients. Some applications of this method include peer-to-peer messaging, SMS marketing, alerts, info-text, web-to-mobile content and various notifications. An SMS Gateway system is said to provide developers and integrators access to secure, reliable, international, high capacity SMS messaging platforms, with potential to design and deploy an array of mobile data applications through any of several APIs via protocols such as SMPP, HTTP/S, FTP, XML, COM Object and the like. Not surprisingly, SMS is used extensively and has been incorporated into existing CRM, E-mail and accounting systems with many expansive applications being reported.

In one exemplified application, U.S. Patent Publication No. 20020187794 describes a system and method for enabling an end user customized management of SMS messages. As explained in this publication the functionally and power of the SMS Center (“SMSC”) is extended to incorporate an array of features, including e-mail type automatic replies, forwarding, filtering, and saving and deleting of SMS messages on wireless handsets and other communication devices. Some applications enabled by this method are said to include an automatic reply when the message receiver is unavailable, such as on vacation, an auto reply option when phone numbers are changed, automatic SMS forwarding, and a reconfigured automatic deletion of undelivered messages, such as stored messages that have not been forwarded or time-mooted messages. Equipment to carry out this method includes an SMS automatic handling server (SAHS) for handling message management for a message receiver (MR), which is used for setting up automatic handling instructions (AHI) on the SAHS. Also included is an auto-reply message server (ARMS) that allows a user to set up automated responses for incoming SMS messages. The ARMS is also equipped with a database that stores ARM messages and a server for serving auto-reply messages to the SMS center. The MR sets up auto-reply messages (ARM) on the ARMS. Further included is a SMS center (SMSC) for managing the sending and reply process, of which the SAHS and/or the ARMS may be a part. The method also contemplates automatically replying to SMS messages and automatically managing SMS message, and can be configured to for setting up several replies by users such that specific types of incoming messages can be responded to as desired.

In another exemplified method, International Patent Application No. PCT/AU00/01505 0143045 describes a redirection e-mail service which notifies a person that an e-mail message is waiting for them after receiving the message from a sender at the redirection service domain. This method is based on the premise that many people will find it easier to locate a person's telephone number than their e-mail address. The method maintains a database of telephone numbers of people who have registered with the service. If the telephone number is assigned to a mobile phone not registered with the service, an SMS text message will forwarded to the unregistered recipient to the effect that an e-mail is waiting for them, which can be accessed if the recipient assesses the service's web site and registers an e-mail address with the service, which can be either an e-mail address provided from the service or from a referred e-mail service provider.

Next, in International Patent Application No. PCT/SG02/00005 02058304 there is disclosed still another method expansion of SMS capability aimed at facilitating a merchants business. In this method the association of certain keywords with certain offers or events and their use in a wireless data messaging service environment, such as SMS, allows interested parties to be associated with particular offers or events and to elicit an automated and appropriate wireless data response. As explained, for users to register their interest in relation to any offer, they only need to know a designated contact number/address as well as a keyword associated with the offer, which is the only information needed to complete an automated registration process. The method allows an effective means for a business to acquire customers and stay in contact with them, to provide prompt replies to customers and potential customers and to develop a mailing list of customers and potential customers.

Next, in U.S. Pat. No. 6,522,877 there is disclosed another business enhancing method which is said to enable a network operator, or the equivalent, to offer goods or services through a point-to-multipoint message, and to respond to acknowledgement messages transmitted from mobile stations having user's that wish to avail themselves of the offered goods and services. In this system a cellular communications system is operated comprising a Base Station/Mobile Switching Center/Interworking function (BMI) and a plurality of mobile stations, and which includes the steps of transmitting a point to multipoint message, such as broadcast SMS message from the BMI to a plurality of mobile stations, receiving the point-to-multipoint message and transmitting an acknowledgement to the BMI using a point-to-point message.

European Patent Application No. 1322126 discloses a method of enhancing business operations worldwide in which a mobile phone user can receive mobile phone network text messages even though they are in an area where their mobile phone cannot be used or does not work, or under circumstances where their mobile phone has run out of battery power. In this method text messages in a mobile phone network are selectively redirected to e-mail addresses. The method employs a gateway apparatus in combination with a database storing a mapping of text message destinations onto e-mail addresses, wherein an address obtaining means is configured to obtain e-mail addresses from the mapping in the database. As further explained, this method operates on the knowledge that Internet connections are readily available in “Internet cafes” and hotel and airline business centers. Thus, in many cases where a mobile phone call is placed, for example, in an attempt to order goods or services, and the mobile phone connection is subsequently interrupted or lost, a sale may still be consummated through an Internet connection, to thereby provide an added boost for merchants.

In International Patent Application No. PCT/SE98/02057 9929127 there is discussed yet another business enhancing method, in which the requirement of a user to manually input a new telephone number of an intended recipient into the memory mode of a mobile phone is eliminated. This accomplished by a tagging system for SMS messages with a header describing the information as a new phone book entry. The mobile phone then receives the message, and based on the header automatically adds it to the mobile phone book. In an alternative mode, after receiving the SMS message service phone number with the header the mobile phone can request the user to authorize the phone to automatically add the phone number to the mobile phone book. In a further embodiment, in the event of standardized electronic business cards sent with an SMS message with an appropriate header describing the electronic business card as a phone book entry the mobile phone automatically adds the electronic business card information to the memory of the mobile phone book.

As can be seen, SMS messaging provides not only a convenient means for world-wide person-to-person private messaging, but also has provided a powerful business tool for discreetly sending and receiving certain types of information useful in business transactions, including up to date breaking news, sports and financial information. Merchant use of SMS messaging, however, has yet to be fully exploited, with even more convenient and effective use of this mode of information transmission yet to be provided.

### SUMMARY OF THE INVENTION

In accordance with that set forth above the present invention provides a new and effective SMS message-based business method, a system for carrying out its operation and a method in general of conducting retail, or any, services and/or goods for purchase vending business via the use of mobile phone devices. More particularly, the present inventive method comprises the steps, or otherwise operations, of a caller and would be purchaser of goods and/or services placing a telephone call from a mobile phone device through an advertised number to a merchant or merchant service provider of goods and/or services, with the purchasers mobile phone service subsequently receiving an SMS message from the merchant or merchant service provider in which the SMS message text sets forth, for example, inter alia, a menu of goods and/or services for purchase, terms of purchase of various services or goods for sale, and a fee schedule for purchases and/or a request for payment confirmation. Upon acceptance of the SMS message text, for example, for particular services for a set fee, the caller/purchaser is then billed or charged a fee which then allows the caller/purchaser access to the advertised telephone services for a predetermined time period. Upon expiration of the time period, the caller/purchaser's mobile phone service is forwarded a second SMS message requesting the caller's agreement to be billed or charged a further fee for a second predetermined time period for the advertised telephone services, or an otherwise second time prescription period for telephone services. This operation is repeated as desired for any number of cycles.

The present invention with its wide array of practical embodiments and applications will be better understood with reference to the following Detailed Discussion of Preferred Embodiments with accompanying drawings.

### BRIEF DESCRIPTION OF THE DRAWINGS

FIG. 1 is an illustrative schematic diagram of a conventional embodiment of SMS message usage relating to a mobile phone user receiving an SMS message from an SMS service center indicating that an intended recipient of a telephone call has acquired a new telephone number.

FIG. 2 illustrates by schematic diagram a mobile phone device goods and/or services for purchase method and system employing SMS message(s) in accordance with the present invention.

FIG. 3 illustrates by schematic diagram another embodiment of a mobile phone device goods and/or services for purchase method and system employing SMS message(s) in accordance with the present invention.

FIG. 4 illustrates by schematic diagram another embodiment of a mobile phone device goods and/or services for purchase method and system employing SMS messaging in accordance with the present invention.

FIG. 5 illustrates by schematic diagram another embodiment of the present invention.

FIG. 6 illustrates by schematic diagram another embodiment of the present invention.

FIG. 7 illustrates by schematic diagram another embodiment of the present invention.

### DETAILED DESCRIPTION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

The present invention provides a novel, convenient and efficient method for conducting a retail or services-vending business operation by exploiting the tremendous advantages and opportunities of the SMS messaging system. In its broadest sense the inventive method comprises the operations of a caller, or potential purchaser of goods or services (i.e. a “would be purchaser”), dialing an advertised telephone number from any sort of a mobile phone device with the intent of exploring the possibility of purchasing goods and/or services through the telephone number connection. Upon a determination that the caller is using a mobile phone device, the caller is then forwarded an SMS text message which can set forth, inter alia, available goods and/or services for purchase, terms of purchase, a fee schedule for goods and/or services purchase and a request for payment confirmation, or payment terms. Upon acceptance of the SMS text message, for example, for certain services for a set fee, the caller is billed or charged a fee which then allows the caller access to the advertised telephone services for a predetermined time period. Upon completion of the time period, the caller's mobile phone device is forwarded a second SMS text message requesting the caller's agreement or approval to be billed or charged a further fee for a second predetermined time period for the advertised telephone services, or otherwise for a second time prescription period, which operation, of course, can be repeated for any number cycles.

The Short Message Service, or SMS, protocol is well known and widely used for data transfer, or text transfer, through Short Message Service Centers (SMSC) between mobile devices and is a service provided by current GSM networks and other networks for sending short messages over a signaling channel. Using this system (and similar systems like it) an originating caller, or return caller, can dial a phone number to leave a short message, such as an alpha numeric message, on the display of a recipient mobile phone. For example, one specific short message type handled by digital wireless networks enables receiving mobile devices to be remotely managed by a remote device management system supporting an array of different applications. Specific SMS messages and applications necessitate or require parameter change commands or specific software and applications to be applied to a digital wireless network and/or receiving mobile phone device, which are sometimes referred to as a “Configuration SMS”.

Such configuration systems may be used, for example, in methods to remotely manage GSM or GPRS-connected mobile devices from a device management application by using the SMS as a content vehicle to carry configuration parameters to be applied as contemplated to a device. SMS may also be used as a form of trigger to which a device responds by launching a connection to a management server to perform management orientated synchronization activities, such as inventory, configuration and software download. As an example of such usage, see U.S. published patent application No. 20030236981. Any of such applications or modes of use of SMS are contemplated for use with present inventive method and system.

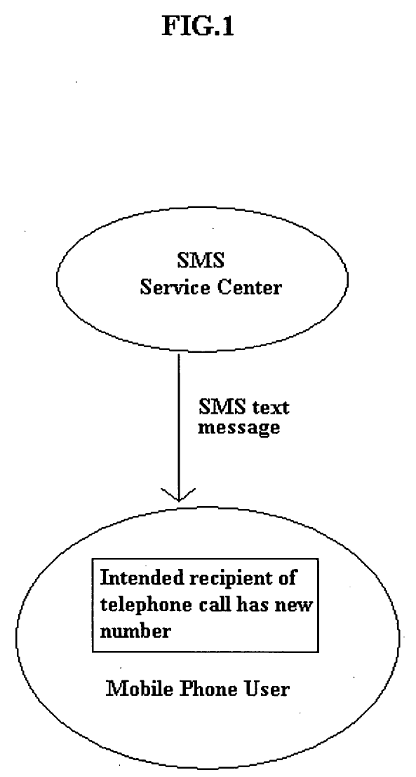

In another rather simplified example, such as shown in FIG. 1, SMS has been used to communicate phone numbers to a recipient mobile phone user. In this example, as illustrated, a mobile phone user has been informed via an SMS service that the intended recipient of the SMS message has a new number. Upon receipt of the SMS message indicating the new number, the new number, for example, as in the case of the present invention a merchant's number, can be entered into the data entry mode of the mobile phone, and then called by the mobile phone device user. This mode, of course, is contemplated as working in the reverse as well and is useful for integration within the present invention.

Further, various security measures have been reported to protect such transmissions from theft or otherwise unwanted molestation. See, for example, U.S. published patent application No. 200330236981. Any of such measures are also contemplated for use in the present invention.

Any conventional, or non-conventional, mobile phone device or the equivalent thereof is also contemplated for use in the inventive method and system, including cell phones from any catalog of the many mobile phone device vendors, some of which have the capability and appearance of a personal computer, or which are generally multifunctional. The inventive method is also contemplated for use with any mobile communication network.

The vending and purchase of any goods and services which can be bought and sold over the telephone is contemplated in conjunction with the present invention. For example, as used herein the term “telephone services” is defined as any service that can be conducted over telephone lines, such as dedicated or a public telephone system or a wireless telephone system or operation, with some non-limiting examples including for, illustration purposes only, dating services, match making services, adult content services, technical support or know-how services, language learning, tutoring or other educational services involving a virtually limitless array of subject matter and topics. Further illustrative examples of services offered, bought and sold via the present inventive method and system can include any type of professional service, such as legal services, medical services, psychiatric or psychological services, marriage counseling services and counseling services in general, which can be advantageously provided by the invention in an on the spot emergency basis if need be. Additional examples of services include gaming, gambling and handicapping services, architectural, business, and accounting services, and really anything or any type of information that can be sold on a time basis for a fee.

As examples of goods and/or related services which may be time-purchased via the present invention, included without limitation, are tolls, fines, music, movies, and computer software and all executable products, financial products, application products, design and engineering products, drawing and architectural products and any and all search products including personal histories, genealogies, criminal histories, automotive histories, and business histories and the like. In short, a description of services and goods time-purchased in accordance with the present invention can only be limited by one's imagination, which is included in this invention as well.

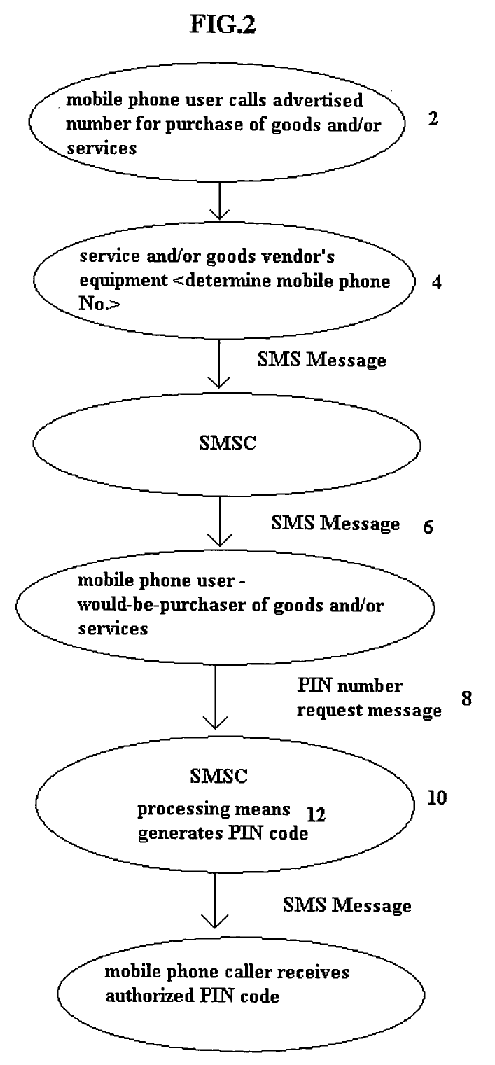

Turning now to FIG. 2, there is depicted a flow diagram of one preferred embodiment of the inventive method and system with various optional components and features, and which is highly flexible and alterable to any desired or contemplated scheme or business plan without departing from the scope of the invention. In FIG. 2 a mobile phone device, e.g. cell phone, user and would be purchaser (2) places a call to a number which is one advertised or made available for purchase of various services. The call is received by a service vendor's equipment (4), and the caller's mobile telephone number determined. Next, the caller-would be purchaser is forwarded an SMS text message (6) which can take any of several forms. For example, in one embodiment the caller may be sent a specific text message witch offers a way to bill the cost or fee of the desired purchased services to their cell phone service. In another embodiment, the caller may be offered via a SMS text message routed to the cell phone number a menu choice number for the cell phone user to actuate with an instructional prompt as to fee payment methods. After receiving specific use instructions from any of such embodiments, as, for example, prompted on the vendor's configured platform, the cell phone caller can then send a “pin number request” message (8) which is received and processed by a Short Message Service Center (SMSC) (10). Next, the SMSC (10), after receipt and processing of the request message (8), through, for example, automated means or preconfigured platform (12), forwards the cell phone user an SMS message containing an authorized PIN code (14), or perhaps one or a plurality of text SMS messages, such as instructional and/or warranty or terms of use messages in concatenated form, in conjunction with an authorized PIN code. An example message can be the following sequence:
i) “Thank you for joining our service!”
ii) “Remember, you PIN CODE is good for only XX minutes worth of access to our service and is good for a period of XX hours.”
iii) “Here is your PIN CODE, XXX. Call the number you originally called and enter you PIN CODE as requested. Please allow for X minutes for activation.

The ATM can then communicate the activated PIN CODE to the vendor's operation for verification purposes, for example, preferably through a dedicated IP address. Upon receipt, the vendor can then store the Activated PIN CODE for data base retrieval, read and verification for, say, a period of XX hours. After the purchased prescribed time period has elapsed the vendor can then delete the PIN CODE, for example, by time lapse automatic means, from an approved list for reissue and reactivation in future timed service purchases.

As can be seen, many other options and features may be implemented with this preferred embodiment, such as, for example, the cycle of caller purchase of timed vendor provided services via SMS text messaging being repeated a plurality of times, a feature limiting service(s) purchases to a set maximum fee of services purchased per time period, such as a maximum dollar amount of timed services purchased per month, or a social security number verification and/or age verification for the timed purchase of certain services. Additionally, the issuance of PIN CODES may be determined by algorithm or an equivalent random generator such that assigned patterns of numbers can be avoided in an effort to thwart fraudulent service usage.

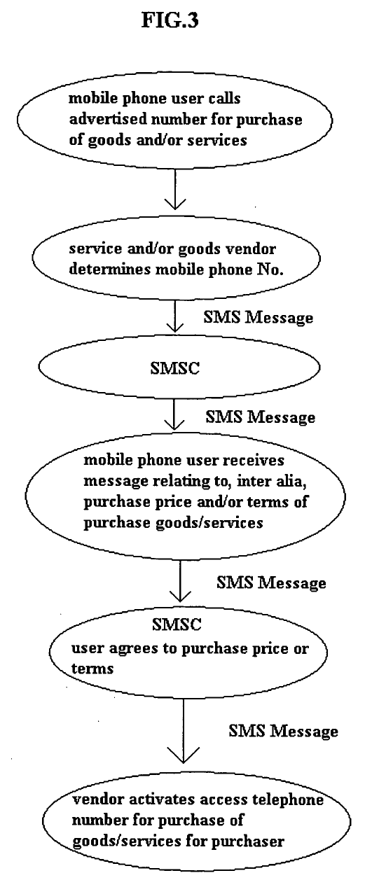

A wide array of additional embodiments of the present invention is also contemplated, such as, for example, and without limitation, the method and system illustrated in FIG. 3 wherein a PIN code is not employed or required. In such embodiments, upon receiving an SMS message(s) and agreeing to terms, such as billing charges and the like, a telephone number for the receipt of services (or goods as desired) will be activated by the inventive method and system for a prescribed amount of time, and reactivated for additional prescribed amounts of time as the case may be.

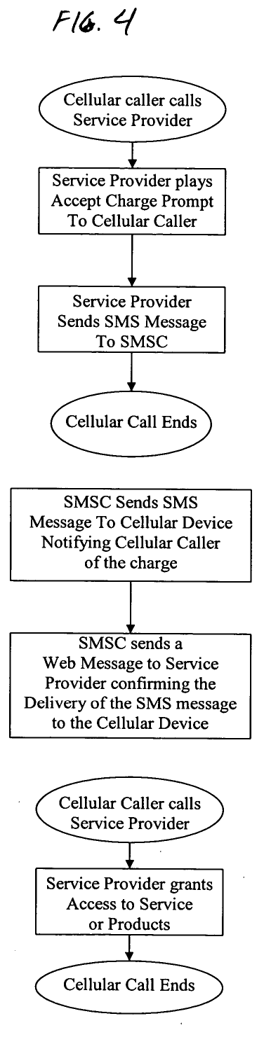

In another example shown in FIG. 4 in accordance with the invention, a cellular caller calls a service provider with a contemplated purchase of goods and/or services. The service provider in response plays an accept charge prompt to the cellular caller, which may be, for example, an automated message. The service provider then sends an SMS message to a SMS Service Center (SMSC) and the cellular call ends. Next, the SMSC sends an SMS message to the mobile phone device of the cellular caller notifying the cellular caller of charges for goods and/or services. The SMSC also sends a Web message to the service provider confirming the delivery of the SMS message to the caller's mobile phone device. The caller then calls the service provider and, depending upon, for example, whether charges were accepted, the service provider grants the caller access to service(s) and/or product(s).

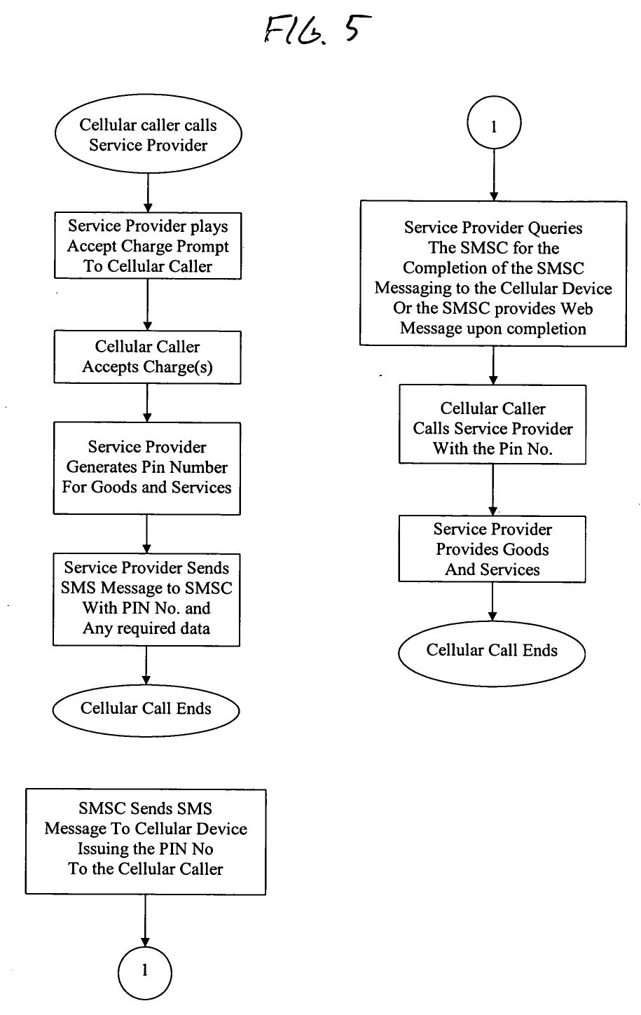

In FIG. 5 another exemplified embodiment of the invention is provided, in which a cellular caller calls a service provider with the contemplated purchase of goods and/or services, and in response the service provider plays an accept charge prompt to the cellular caller who accepts the charge(s). The service provider then generates a PIN number for access to goods and/or services and sends an SMS message to an SMSC with the generated PIN number and any or all other required data. The SMSC next sends an SMS message to the cellular caller in which the PIN number is issued to the caller. Optionally, the service provider may query the SMSC for completion of the SMSC messaging to the mobile phone device of the cellular caller, or the SMSC may provide a Web message to the service provider confirming the SMS message to the caller and issuance of the PIN number. The cellular caller may then call the service provider and provide the issued PIN number for access to goods and/or services as desired or contemplated.

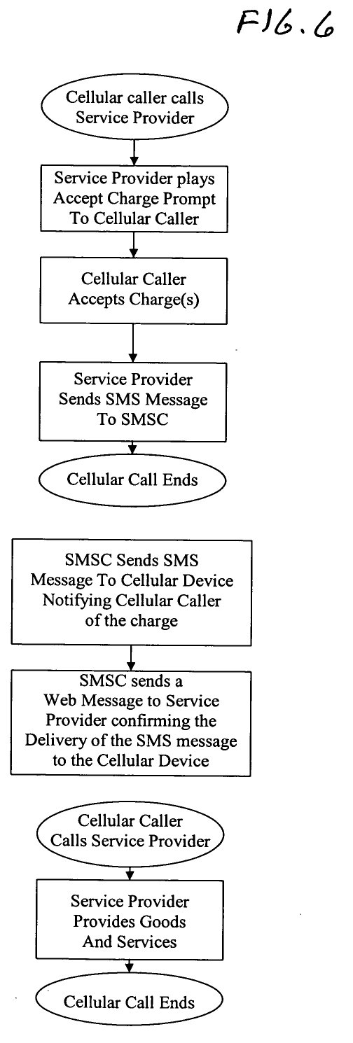

Next, in FIG. 6 an additional embodiment of the invention is schematically portrayed, in which a cellular caller, would-be-purchaser, first calls a service provider, and in response the service provider plays an accept charge prompt to the cellular caller who either accepts or does not accept proposed charges and/or terms of purchase for contemplated goods and/or services. Upon acceptance, the service provider sends an SMS message to the SMSC, which sends an SMS message to the mobile phone device of the cellular caller notifying the caller of the charge(s). Optionally, the SMSC can send a Web message to the service provider confirming the delivery of the SMS message to the mobile phone device of the cellular caller. The cellular caller may then call the service provider to gain access to contemplated goods and/or services.

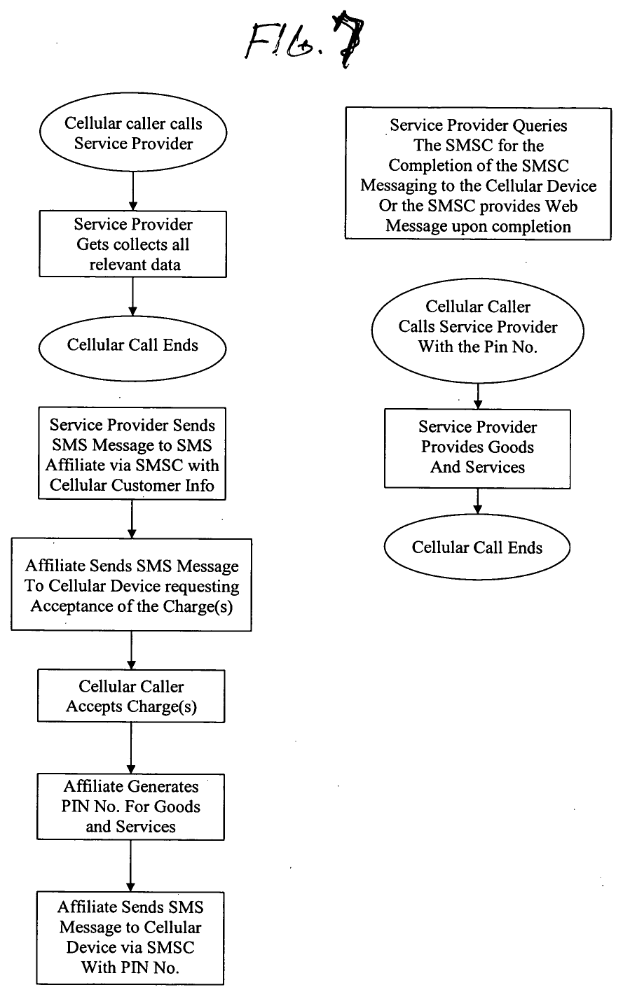

In the schematically portrayed embodiment of FIG. 7, a cellular caller/would-be-purchaser calls a service provider with the contemplated purchase of goods and/or services, and in response the service provider obtains from the caller relevant and/or requested information, such as identification, electronic purchase information and the like. The service provider then sends an SMS message to an SMS affiliate via an SMSC with the cellular customer information as provided. The affiliate sends an SMS message to the mobile phone device of the cellular caller requesting acceptance of proposed charge(s) and/or purchase terms. Upon acceptance of same by the cellular caller the affiliate generates a PIN number for purchase or access of the caller to contemplated goods and/or services, and sends an SMS message to the mobile phone device of the cellular caller via an SMSC presenting the PIN number. Optionally, the service provider may query the SMSC for completion of the SMSC messaging to the mobile phone device of the cellular caller, or a Web message may be provided to the service provider by the SMSC upon completion. The cellular caller then calls the service provider and presents the issued PIN number for access to contemplated goods and/or services.

It is also contemplated that the present invention be used in conjunction with any and all conventional SMS methodology and technology, such as, for example, World-Text Two-way SMS services which allow for sending and receiving SMS messages to and from an application or a person's e-mail, and the transmission of graphics and/or picture images via SMS messaging and the like.

While the invention has been described in connection with what is presently considered to be the most practical and preferred embodiments, it is to be understood that this invention is not to be limited to the disclosed embodiments in any way which are merely set forth for illustrative purposes; to the contrary the present inventive method and system, and method for conducting business in general, is intended to cover an array of various modifications and equivalent arrangements all of which are contemplated for inclusion within the spirit and scope of the disclosure and appended claims.

1. A method for purchase of goods and/or services comprising the steps of,
(a) a caller or would-be-purchaser calling a service provider/vendor from a mobile phone device;
(b) an SMS message being forwarded to the would-be-purchaser's mobile phone device relating to purchase of services and/goods options and/or terms of procuring services and/or goods;
(c) upon acceptance of the contents of the SMS message, the would-be-purchaser or caller is billed or charged a fee which allows the caller's access to telephonic and/or Internet vendor provided services and/or goods for a first determined time period.

2. The method of claim 1 further comprising the step wherein upon completion of the first determined time period, the caller's mobile phone device is forwarded a second SMS message relating to the caller's agreement or approval of the contents of the second SMS message to be billed or charged a fee for a second determined time period for access to telephonic and/or Internet vendor provided services and/or goods.

3. The method of claim 2 comprising a plurality of SMS messages which are forwarded to the caller relating to the caller's agreement or approval thereof to be billed or charged a fee for a plurality of determined time periods for access to telephonic and/or Internet vendor provided services and/or goods.

4. The method of claims 1, 2 and 3 wherein said services and goods are selected from the group consisting of dating services, match making services, adult orientated services, technical support or know-how services, tutoring, language learning, and educational services, professional services including legal, medical, psychiatric, psychological, marriage counseling and counseling services in general, gaming and gambling services, computer software and any and all executable products, financial products, application products, design and engineering products, drawing and architectural products, tolls, fines, music, and any and all search products, including personal histories, genealogies, criminal histories, automotive histories, and business histories.

5. A system comprising a method for purchase of goods and/or services comprising the steps of,
(a) a caller or would-be-purchaser calling a service provider/vendor from a mobile phone device;
(b) an SMS message being forwarded to the would-be-purchaser's mobile phone device relating to purchase of services and/or goods options and/or terms of procuring services and/or goods;
(c) upon acceptance of the contents of the SMS message, the would-be-purchaser or caller is billed or charged a fee which allows a the caller's access to telephonic and/or Internet vendor provided services and/or goods for a first determined time period.

6. The system of claim 5 further comprising the step wherein upon completion of the first determined time period, the caller's mobile phone device is forwarded a second SMS message relating to the caller's agreement or approval of the contents of the second SMS message to be billed or charged a fee for a second determined time period for access to telephonic and/or Internet provided vendor provided services and/or goods.

7. The system of claim 6 comprising a plurality of SMS messages which are forwarded to the caller relating to the caller's agreement or approval thereof to be billed or charged a fee for a plurality of determined time periods for access to telephonic and/or Internet vendor provided services and/or goods.

8. The systems of claims 5, 6, and 7 wherein said services and goods are selected from the group consisting of dating services, match making services, adult orientated services, technical support or know-how services, tutoring, language learning, educational services, professional services including legal, medical, psychiatric, psychological, marriage counseling and marriage counseling services in general, gaming and gambling services, computer software and any and all executable products, financial products, application products, design and engineering products, drawing and architectural products, tools, fines, music, and any and all search products, including personal histories, genealogies, criminal histories, automotive histories, and business histories.

9. A method of conducting business comprising the use of a method for purchase of good/or services such as recited in claim 1.

10. A method of conducting business comprising the use of a method for purchase of goods/and services such as recited in claim 2.

11. A method of conducting business comprising the use of a method for purchase of goods/and or services such as recited in claim 3.

12. A method of conducting business comprising the use of a method for purchase of goods and/or services such as recited in claim 4.

13. A method of conducting business comprising the use of the system recited in claim 5.

14. A method of conducting business comprising the use of the system recited in claim 6.

15. A method of conducting business comprising the use of the system recited in claim 7.

16. A method of conducting business comprising the use of the system recited in claim 8.
